(19) United States
(12) Patent Application Publication
(10) Pub. No.: US 2003/0164557 A1
(43) Pub. Date: Sep. 4, 2003

(54) Interactive, automated aroma diffuser with interface to external device

(76) Inventors: Caleb Chung, Boise, ID (US); Gary Schwartz, Boise, ID (US)

Correspondence Address: PEDERSEN & COMPANY, PLLC, P.O. BOX 2666, BOISE, ID, 83701, US

(21) Appl. No.: 10/351,100

(22) Filed: Jan. 22, 2003

Related U.S. Application Data
(60) Provisional application No. 60/351,454, filed on Jan. 22, 2002.

(51) Int. Cl. B01F 3/04

(52) U.S. Cl. 261/26; 261/DIG. 88

(57) ABSTRACT

An aroma diffuser that may be adapted to cooperate with a computer, television, CD player, or other media device that is separate and external to the diffuser, to emit one or more aromas into a room or space upon a signal from said external device. The signal from the external device may be wired or wireless, but preferably is a wireless, audible signal included in the CD, VHS, or other pre-recorded media. This way, the control signal is produced by playing of the media on a commercially-available external device, such as any television, without modification of said device's hardware or firmware. Optionally, the diffuser may be manually controlled, or may have multiple modes so it can be manually controlled by the user, or controlled through the user's PC, audio player, or television/VCR unit. The diffuser system may direct/connect the user an internet website for purchase of scent products or other accessories for the system.

### DESCRIPTION

This application claims priority of provisional application Serial No. 60/351,454, filed Jan. 22, 2002, the disclosure of which is incorporated herein by this reference.

### BACKGROUND OF THE INVENTION

1. Field of the Invention

This invention relates generally to the sense of smell, the science of aromatics, and aromatherapy. More specifically, this invention relates to an interactive, automated, aroma diffuser with convenient interface systems for a personal computer, a television, and/or other media systems.

2. Related Art

Various scent-producing devices have been patented for home and office use. In some of the scent-producing devices, the user manually selects a desired aroma, while, in others, a timer system is employed for producing aromas according to a predetermined schedule.

U.S. Pat. No. 5,805,768 (“Schwartz, et al.”) discloses a multi-scent diffuser with a removable tray having plurality of receptacles for retaining aromatic materials, and a system for rotating the tray to align a selected receptacle with the heating means, and thereby releasing an aroma from the selected receptacle. Schwartz, et al. discloses a lid system for allowing the scent from the selected receptacle to waft into a room, and a means for sealing the non-selected receptacles to hinder evaporation.

Murayama (U.S. Pat. No. 6,282,458), Ivey, Jr. (U.S. Pat. No. 6,231,032), Budman (U.S. Pat. No. 6,024,783), Manne (U.S. Pat. No. 6,169,595), Watkins (U.S. Pat. No. 5,591,409), and Rasouli (U.S. Pat. No. 6,004,516) disclose various aroma emitting devices, some of which are wired to, and controlled by electrical signals from, a computer device.

### SUMMARY OF THE INVENTION

The invention comprises an aroma diffuser that may be adapted to cooperate with a computer, television, CD player, or other device external to the diffuser, to emit one or more aromas into a room or space upon a signal from said external device. The signal from the external device may be a wired or wireless signal, but preferably is a signal that may be produced by a standard external device without modification of said device's hardware or firmware. In a preferred embodiment, a television/VCR/VHS, a computer, an audio CD player, or other audio or audio-video device emits an audible signal(s) that trigger(s) an action or actions by the aroma diffuser. The preferred diffuser may be used as a stand-alone unit, without connection to or cooperation with an external device, to emit aromas according to a preprogrammed or pre-selected sequencing.

### BRIEF DESCRIPTION OF THE DRAWINGS

FIG. 1 is a schematic view of one embodiment of a diffuser system according to the invention.

FIG. 2A is a perspective view of a preferred embodiment of the invented diffuser unit, showing a scent cartridge being slid into the diffuser unit, wherein this embodiment includes a “nautilus” shape of external housing.

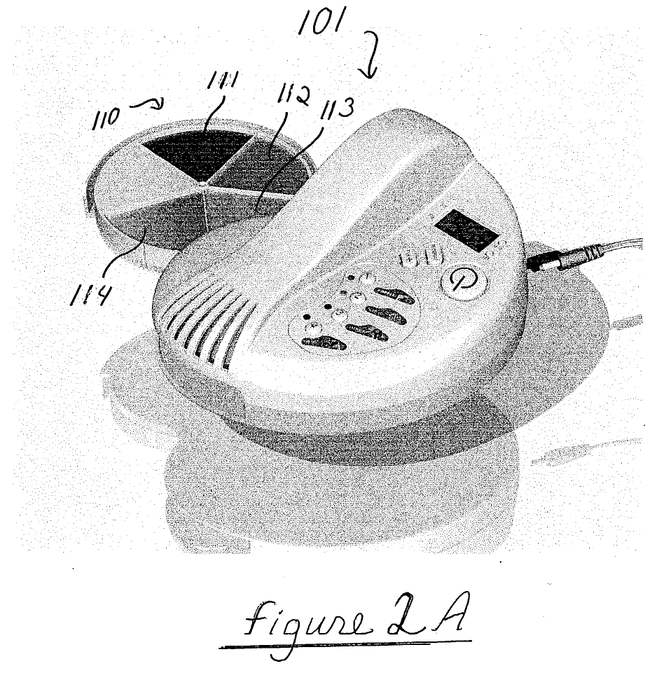

FIG. 2B is a close-up perspective view of the manual control panel of the diffuser unit of FIG. 2A.

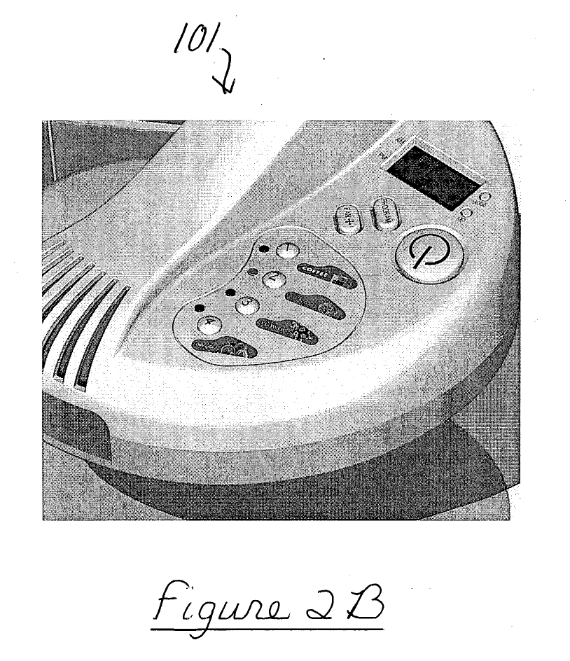

FIG. 3 is an exploded view of the diffuser unit of FIGS. 2A and 2B.

FIG. 4 is an exploded view of an alternative embodiment diffuser unit.

### DETAILED DESCRIPTION OF THE INVENTION

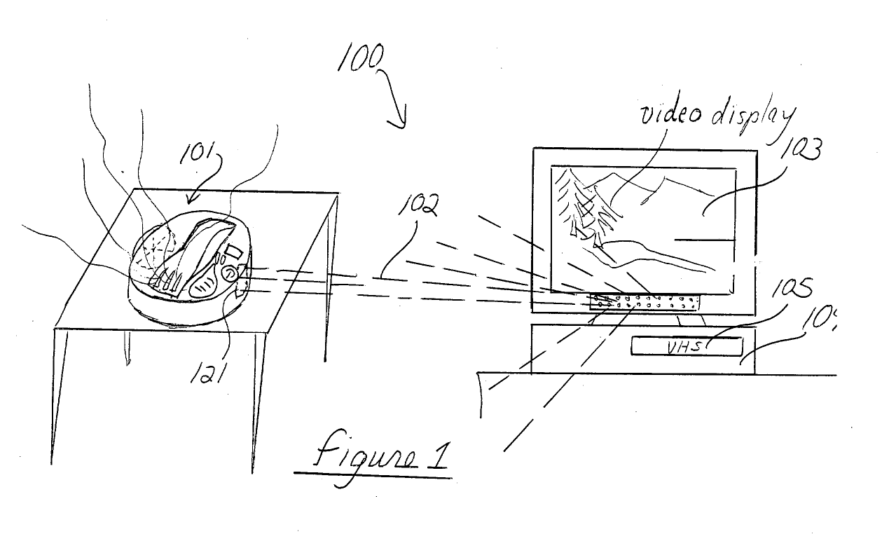

Referring to the Figures, there are shown some, but not the only embodiments, of the invented aroma diffuser system 100 and diffuser 101. In FIG. 1, there is shown a diffuser 101 that is receives an audible tone sequence signal 102 from a television 103 with a VHS-VCR unit 104. The signal 102 is actuated by/prerecorded on the VHS tape 105 which also has a prerecorded video program and music. The signal 102 is received by the diffuser microphone 121, and, thereby, actuates the programming/code contained within the diffuser to operate the diffuser to produce a sequence or scents corresponding to the video and music program on the VCR.

A diffuser 101 is provided with a cartridge of scent-producing compartments or another type of cartridge 110 that contains scent-producing materials. Preferably, these materials are contained in four trays 111, 112, 113, 114, and are chosen for their characteristic providing a scent into a space to create a special atmospheric effect. Preferably, these materials do not require a heating device in order to produce their particular scent, but a fan may be used to distribute the scent to the room. For example, a scent cartridge for a “coffee shop” atmosphere may include coffee, cinnamon, baked goods, orange, chocolate, and other spice scents, etc. A cartridge for a “county garden” atmosphere may include various floral or herbal scents. A cartridge for an “ocean-side” atmosphere may include a salt-air scent, wood or sea-weed scents, or sea-life scents.

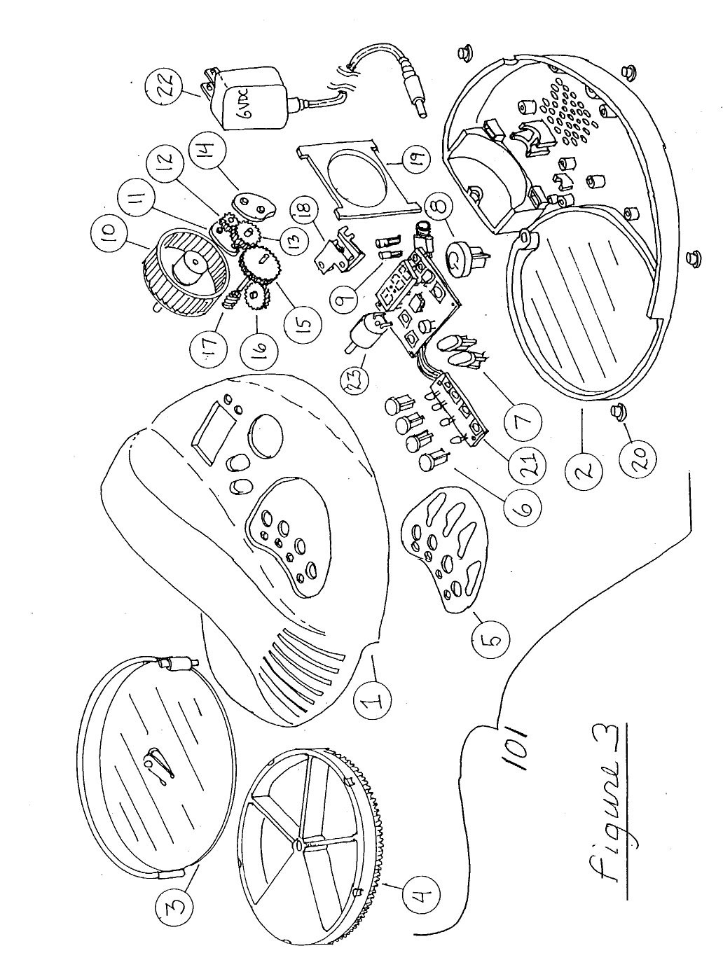

The diffuser 101 includes programming that is adapted to perform a sequence of actions, preferably including emitting of different aromas or combinations of the aromas into the air in the surrounding room, or into a supplied duct or vent system, by a fan (10 in FIG. 3)system. The programming code may allow the user to request, in manual mode, one of a plurality of aromas to be emitted upon touching a button or a keypad with indicia (5, 6 in FIG. 3) on the diffuser. For example, the user may manually request only the “coffee” scent, or the “orange” scent from the “coffee shop” cartridge by selecting the first, second, third, or fourth receptacle in the cartridge, for example. Or, the programming may allow the user to request an entire pre-programmed sequence, wherein the dispenser will automatically switch from coffee, to cinnamon, to orange, to chocolate, for example, in an ordered pattern and timing that is predetermined by the programming software/firmware.

The programming may be predetermined as part of a controller that is original manufacture equipment (OEM), so that sequences of aromas are preset, for example, 15 minutes per scent starting at the first position of the scent cartridge and sequencing through all the scents in the cartridge and then repeating the sequence, or one hour for the first scent, followed by 15 minutes each for the second and third scents, and a final one hour fourth scent time period, with or without one or more repeats. Or, more preferably, the sequence may be controlled by programming input by a disk, tape, CD, or other code means that may be inserted as desired. For example, an ocean scent cartridge may be supplied with a CD or disk that provides information for sequencing the scents in an optimum or unusual manner to provide variety and uniqueness for the user.

Most preferably, the timing and sequencing of the scent production matches, and is operatively connected to, the programming or signals produced by an external device. For example, a computer CD is supplied with a scent cartridge, and the CD is installed in a computer and the scent cartridge is installed in the diffuser. Upon playing of the CD, visual images are displayed on the computer screen that are related to the atmosphere being portrayed. For example, forest scenes or a walk in the woods is portrayed as animation, photography, or a motion picture style display, and scents from the diffuser are synchronized with the change of scenery or music in the video display. Further, the CD may include control screens for the user to control or at a minimum to start the display and scent diffusion.

Another embodiment includes a VCR tape or other media cooperating with a television, wherein playing the VCR tape creates a pleasing or interesting video display, preferably with the sound effects appropriate for the video, and scents from the diffuser are synchronized with the change of scenery or music in the television display.

With either of these embodiments, or with other CD, music tape, or video embodiments, the audio/video device may be wired to the diffuser, or a wireless system may be used for the audio/video external device, for signaling the diffuser to control the diffuser's performance steps. More preferably, however, there is no wiring between the diffuser and the external device and the external device is a standard “off-the-shelf” audio-video device available on the market for conventional use. Preferably, no alteration to the standard, off-the-shelf external device is needed, including no alternation to the device's hardware or firmware. Preferably, the signal from the external device is an audio signal emitted at a volume that a microphone in the diffuser picks up the signal, and the programming in the diffuser recognizes the audio signal as a signal to commence/alter its performance steps. For example, the “woodland walk” VCR tape would, at times corresponding to changes in scenery or music on the “walk,” emit a pattern of audible tones that would be sensed and recognized by the diffuser as commands to step to another scent.

The preferred audible tone would be a sequence of a plurality of tones that would be different from, and not confused with, the typical surrounding noise in a home or office, and would not be confused with the music of the invented presentation. Further, filtering or other noise suppression may be used to help make the audible signal system effective and accurate. With such a system, little or no modifications need be made to the standard external device, as it is a platform for playing of the audio/video media that includes the signals necessary for control of the diffuser. For example, the preferred external device need not include means to create or send infrared, ultrasonic, or other signaling means for signaling the invented diffuser, except preferably audio means such as already available in television, VCR, or computers with audio or speaker systems.

Further, in the computer-based embodiment, control screens may be supplied to allow complete or partial control by the user of the diffuser, and this may be applied to versions that use the audible signaling system. Further, control screen(s) and windows, buttons may be provided to let the user automatically connect to an internet web site for ordering more scent cartridges, more tapes or CD's, or other accessories for the diffuser system.

Controls and features available by manual control, or by remote signal, may include “fan speed increase or decrease,” “move tray/cartridge,” and switching to various modes (manual, program/PC and TV/CD). Examples include:

1. Manual Mode: Tray and Air volume are directly controlled by user.

2. Program/PC Mode: When in this mode, and when connected to the PC, all functionality is controlled by the PCT and is interactive with the CDROM cartridge. Also from this mode, customization of the default, stand-alone mode or manual mode, can be modified (via software PC interface). When in this mode, but not connected to the PC (Program Mode), this mode runs the stored routine that has been downloaded from the PC. When no program is present, this mode defaults to a factory preset routine (for example, one hour for each scent tray 1 through 4 and then repeat).

To re-program the factory default settings and create a custom program, the following sequence can be followed.

A) turn on; B) hold Select button down for 3 seconds—Program/PC Mode LED flashes in this mode; C) using left and right arrow buttons, select desired tray; D) using fan strength button, select power level; E) press On/Off button to set time increments—10 second increments in Demo Mode—Manual LED will flash each time; and F) repeat with each tray setting, that is, for a four-tray cartridge, repeat for trays 1, 2, 3, and 4; G) press the select mode button once more to confirm final program sequence. LED stops flashing. The cartridge will cycle once to show user that the programing is set.

3. TV/CD Mode: This mode is used in conjunction with VHS or audio CD-enabled scent cartridges.

A) A microphone mounted in the diffuser unit picks up audio tones emitted by either VHS or CD audio, and the audio tones switches the cartridge to the corresponding tray/cartridge portion for the appropriate scent. This provides to “low-tech” wireless controllability, wherein modification to the VHS- or CD-enabled player is not modified, and, instead, a home or office user may enjoy the diffuser system without a large expenditure for a specially-adapted external device. B) For reference an onscreen prompt of th media type and the tray portion is display on screen (VHS) in case the cartridge position gets “out of sync” with the VHS/CD display and its signals.

One of skill in the art of use of audible tones for conveying signals will understand how to implement this preferred wireless feature of the invention, once this Description and the Drawings are viewed.

Further specifications of preferred embodiments may include:

Examples of “S3™” Diffuser Preferred On-Board Electronic Specifications:

Ability to manually or direct control from PC to move the tray to a selected position 1-4.

Self-calibration (using 2 feedback switches that read the tray position and one end limit),

Variable intensity fan output. (In prototype using a varying pulsed on/off duty cycle. At lowest setting, fan is OFF)

E squared memory for updateable, non-volatile memory storage.

A crystal for providing relative time constants i.e., knows how long a minute or an hour is when disconnected from the PC (not a stand alone real time clock.)

3 LEDs for indicating the three modes (these also double as power on indicators).

AC Power fan and step-down transformer for all DC power requirements (electronics and servo tray drive).

On board electronics include a microphone that detects four distinct tone variations that selectively move to trays slots 1, 2, 3 or 4 cycle.

On-board speaker to produce tones or beeps. (TBD)

PC Software Interface:

A user interface console for controlling selection and playback of S3 content, (AVI's Audio, still slides, etc.) Controls include, play, stop, pause, skip to next, repeat, loop and full screen mode.

Additional controls: web access button via sponsored logo,

Content specific resource pages:

Program mode for customizing & downloading the onboard auto routine in stand-alone mode.

Program mode for customizing a routine while connected and controlled by the PC software.

Help button that shows install procedure and trouble-shooting pages. (Interactive and animated in production) Web link to manufacturer and replacement parts, software library and scent collections.

Further Examples of Features of UltraScent™ Quattro™ S3™ Diffuser Unit and Operation:

1. Programmable—Select how long and when you want any of the four different aromas to diffuse.

2. Powerful—Scents rooms in minutes.

3. Co-ordinates Fragrant scenes with corresponding Scents and Sounds on your PC!

4. Will remember its programming from your pc or run in stand alone mode away from your pc.

5. Available with real aromatherapy scent cartridges and easy CDROM to give a complete sensory experience. Select soothing music and scenes to accompany your aromatherapy.

What the software will do: Each CD contains four fragrant programs and comes bundled with a pre-scented tray.

1. Play pre-programmed scenes and scents on your computer.

2. Just play music and scent. Or Scene and Scent or Scent alone or music alone.

3. Virtual vacations right in front of your eyes via your PC.

4. Gives valuable information about the benefits of aromatherapy, the history of aromatherapy and how to get the most from using the healing power of aromas.

5. Will allow the user to select the times when the machine will turn on and off and set the program to run in stand alone mode. Use it as an aromatic alarm clock. Set it to diffuse a specific aroma for any length of time and switch to another aroma for another set period of time.

6. Can tell the diffuser to run intermittently: 20 on 40 off or whatever.

Referring to FIG. 3, there is shown an especially-preferred embodiment. Call-out numbers specifically for FIG. 3, and the preferred materials for these parts, may be described as follows:

| Part # | Part Description | Quantity | Material | Size L × W × H |
|---|---|---|---|---|
| 1 | Top housing | 1 | ABS | 7″ × 6″ × 2″ |
| 2 | Lower housing | 1 | ABS | 7″ × 6″ × 1″ |
| 3 | Swing out tray | 1 | ABS | 5″ × 5″ × ⅝″ |
| 4 | Fragrance | 1 | PVC | 4½″ × 4½″ × ½″ |
| | cartridge (empty) | | | |
| 5 | Fragrance | 1 | CARD | 1″ × 2″ × 1/16″ |
| | cartridge label | | | |
| 6 | Fragrance | 4 | ABS | ⅜″ × ⅜″ × ½″ |
| | selector buttons | | | |
| 7 | Mode and | 2 | ABS | ½″ × ¼″ × ½″ |
| | fan buttons | | | |
| 8 | On/off button | 1 | ABS | ¾″ × ¾″ × ⅜″ |
| 9 | Clock set buttons | 2 | ABS | ¼″ × ¼″ × ½″ |
| 10 | Fan Blade | 1 | ABS | 2½″ × 2½″ × 1″ |
| 11 | Gear housing-left | 1 | ABS | 1′ × ½″ × 1/16″ |
| 12 | Pinion gear | 1 | DELRIN | ¼″ × ¼″ × ¼″ |
| 13 | Spur gear | 1 | DELRIN | ½″ × ½″ × ¼″ |
| 14 | Gear housing- | 1 | DELRIN | 1′ × ½″ × 1/16″ |
| | right | | | |
| 15 | Spur Gear | 1 | DELRIN | ½″ × ½″ × ¼″ |
| 16 | Worm follower | 1 | DELRIN | ½″ × ½″ × ¼″ |
| | gear | | | |
| 17 | Worm gear | 1 | DELRIN | ⅜″ × ⅜″ × ½″ |
| 18 | Gear cover | 1 | ABS | ½″ × 1″ × 1/16″ |
| 19 | Fan duct cover | 1 | ABS | 2½″ × 2½″ × 1/16″ |
| 20 | Rubber foot | 5 | | ⅜″ × ⅜″ × ⅜″ |
| 21 | Electronics | | | (see electronics) |
| 22 | Power Adaptor | | | (see electronics) |
| 23 | Motor | 1 | Purchase | (see electronics) |
| | | | | Total Plastic Parts: |

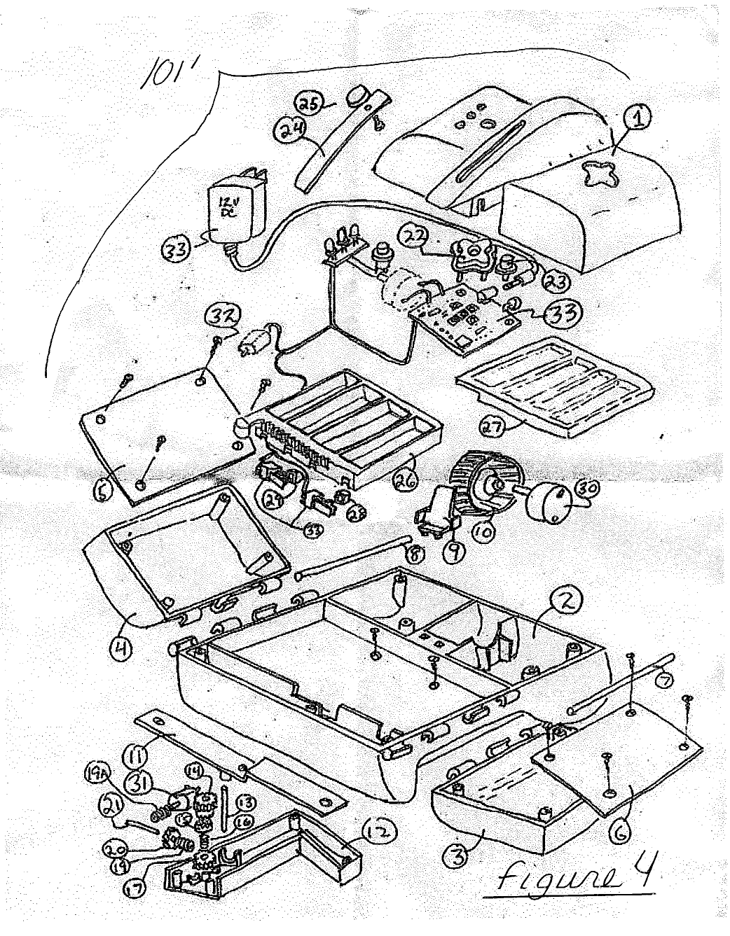

Referring to FIG. 4, there is shown an alternative embodiment. Callout numbers specifically for FIG. 4 may be described as:

1 top housing

2 lower housing

3 swing door-right

4 swing door-left

5 swing door cover-left

6 swing door cover-right

7 and 8 hinge pin

9 fan (shield)

10 fan (included in motor sub assy)

11 switch well cover

12 servo and wiring cover

13 gear shaft

14 drive/clutch crown gear crown/clutch gear

16 spring

17 gear

18 *deleted*

19 and 19a worm gear

20 gear

21 gear shaft

22 button

23 button

24 vent slide cover

25 slide button

26 scent tray(include only in software package)

27 scent tray cover (see 26)

28 and 29 limit switch cover

30 Motor sub assy(motor and fan-see above in electronics)

31 mabuchi motor (see electronics)

32 screws

33 pcb and components(see electronics)

The preferred embodiment, illustrated in the Figures includes many features that make the invented system user-friendly and convenient at an economical cost. The preferred embodiment includes a removable cartridge, and adaptation for calibration of a new cartridge once it is inserted, so that the cartridge properly aligns the trays/compartments in the cartridge with the fan/internals workings of the diffuser. The preferred embodiment includes a diffuser lid system that seals off the other aromas besides that of the selected tray. When not in use, the lid system may be completely closed to seal off all the scents, so that none of the scents tend to evaporate or lose potency. Fan speed is selectable for the size of room being “fragranced.” The cartridges come with resealable lids for use when the cartridge is not in the diffuser. The CDROM disc for PC mode may also be used as an audio CD that can be played on a CD stereo system.

When using the PC interface, an on-screen control panel is preferably provided, that includes icons of the type familiar to many consumers, such as “Play,” “Pause,” “Forward,” and “Rewind.” Also, a speaker icon controls audio volume and a fan icon adjusts the intensity of the aromas from the diffuser. Optionally, the PCT interface may include windows for learning more about the scents or the history or manufacture of the scents or the cultures they represent. An old-world market scent system, for example, might include historical and cultural information accessible from the screen or keyboard of the PC that is “playing” the scent program.

By using the invented diffuser and its adaptations for use with an external audio or audio/video device, a blend of sigh, sound and smell may be achieved, to create a “virtual” environment for relaxation, meditation, or amusement. Holiday themes such as Christmas, Valentine's Day, or Thanksgiving may be designed. Relaxation Themes incorporating vacations, stress relief, and other types of aromatherapy may be designed. Special Interest Themes may be designed, such as cooking, sports, games, and historical adventures.

Although this invention has been described above with reference to particular means, materials and embodiments, it is to be understood that the invention is not limited to these disclosed particulars, but extends instead to all equivalents within the scope of the following claims.

We claim:

1. An aroma diffuser system comprising:
an aroma diffuser unit comprising a microphone adapted to receive an audible tone signal from a computer or television VCR, wherein said diffuser comprises programming code means for advancing a cartridge of scented materials in response to the audible tone signal.

2. The aroma diffuser system as in claim 1, further comprising a VHS cassette comprising prerecorded video signals for display on a screen of said television and comprising one or more of said audible tone signals.

3. The aroma diffuser system as in claim 1, further comprising a compact disc operable in a computer or audio-CD unit, the compact disc having a plurality of said prerecorded audible tone signals.

4. The aroma diffuser system as in claim 3, wherein said compact disc further includes prerecorded video signals for display on a computer screen comprising control icons for controlling said diffuser unit.

5. The aroma diffuser system as in claim 4, wherein said control icons actuate one of said audible signals.

6. The aroma diffuser system as in claim 4, wherein said control icons actuate a signal to the diffuser by means of a wire connection between the computer and the diffuser unit.

7. The aroma diffuser system as in claim 1, wherein said diffuser unit further comprises a manual mode of operation comprising programming code means for allowing manual control by means of control buttons or keys on a surface of the diffuser.

8. An aroma diffuser system for emitting a plurality of scents into a room, the system comprising a diffuser unit containing a plurality of scent materials and a fan for blowing scent from the scent materials into the room, the system further comprising a device external to the diffuser unit adapted to produce wireless signals received by the diffuser unit, wherein said wireless signals actuate said diffuser unit to advance to a subsequent scent.

9. The aroma diffuser system as in claim 8, wherein said external device is a computer adapted to play a compact disc containing prerecorded video scenes and sounds.

10. The aroma diffuser system as in claim 9, wherein said wireless signals are audible tone signals emitted at various times during the playing of the compact disc for triggering the diffuser unit to advance to a subsequent scent.

11. The aroma diffuser system as in claim 9, further comprising icons adapted to connect to an internet website for ordering scent supplies for said diffuser system.

12. The aroma diffuser system as in claim 8, wherein said external device is a television video tape player adapted to play a VHS tape containing prerecorded video scenes and sounds.

13. The aroma diffuser system as in claim 12, wherein said television does not have any wire connections to the diffuser device.

14. The aroma diffuser system as in claim 12, wherein said wireless signals are audible tone signals emitted at various times during the playing of the tape for triggering the diffuser unit to advance to a subsequent scent.

15. The aroma diffuser system as in claim 8, wherein said diffuser unit is further adapted for manual operation by means of a keypad and buttons on said diffuser unit.
